(19) United States
(12) Patent Application Publication
(10) Pub. No.: US 2002/0101150 A1
(43) Pub. Date: Aug. 1, 2002

(54) Color CRT(Cathode Ray Tube)

(76) Inventor: Jae-Hong Jeon, Seoul (KR)

Correspondence Address: BIRCH STEWART KOLASCH & BIRCH, PO BOX 747, FALLS CHURCH, VA, 22040-0747, US

(21) Appl. No.: 09/949,799

(22) Filed: Sep. 12, 2001

(30) Foreign Application Priority Data
Nov. 27, 2000 (KR) P2000-71021

(51) Int. Cl. H01J 29/10

(52) U.S. Cl. 313/461

(57) ABSTRACT

Disclosed is a color CRT(Cathode Ray Tube) including a panel having a fluorescent screen formed at an inner surface of the panel. The fluorescent screen includes fluorescent materials of R(Red), G(Green) and B(Blue) colors in the form of strips, and black matrices arranged between the strip-shaped fluorescent materials of R, G and B colors, wherein a BM width from a central portion of the fluorescent screen to end portions in a direction of the shorter axis satisfies the following formula:

y=ax+b.

Here, ‘y’ represents a BM width in the direction of the shorter axis, ‘x’ represents a distance from the central portion of the fluorescent screen to end portion in a direction of the shorter axis, ‘a’ is defined by the formula

−1.932E-4≦a≦−1.420E-4,

and ‘b’ represents a BM width at the central portion of the fluorescent screen. The present invention has advantages of preventing deterioration of whiteness uniformity caused by a difference in brightness over the screen and also preventing deterioration of brightness uniformity caused by a difference in brightness between the central portion and peripheral portions by enabling a brightness distribution over all regions of the fluorescent screen to be circular-shaped.

### BACKGROUND OF THE INVENTION

1. Field of the Invention

The present invention generally relates to a color CRT(Cathode Ray Tube), and more particularly to a color CRT having improved black matrix, which can obviate such general problems as whiteness uniformity, brightness uniformity, purity clearance, doming portion clearance, etc., by optimizing a distance between black matrix, which is referred to as “BM(Black Matrix) width” herein after, at peripheral portions relative to a BM width at a central portion of a fluorescent screen.

2. Description of the Related Art

FIG. 1 is a view showing a structure of a general color CRT(Cathode Ray Tube). Referring to FIG. 1, the general CRT comprises a panel 1 as a front glass, a funnel 2 as a rear glass coupled to the panel 1, a fluorescent surface 4 coated with fluorescent materials on an inner surface of the panel 1, an electron gun 11 for emitting electron beams 6 incident on the fluorescent surface 4, a shadow mask 3 for selecting colors to radiate the predetermined fluorescent materials, and a frame 7 for supporting the shadow mask 3.

Above-described CRT includes an inner shield 9 for shielding an external magnetic field during their operations, which is fixed to the frame 7 and spring 8, which couples the frame assembly to the panel 1. Also, the CRT is hermetically sealed in a high vacuum state.

An operational principle of the color CRT will be described herein below. First, the electron beams 6 emitted from the electron gun housed in a neck part of the funnel 2 are collided onto the fluorescent surface 4 formed at the inner surface of the panel 1 due to an anode voltage applied to the CRT. At this time, a deflection yoke 5 before reaching the fluorescent surface 4 deflects the electron beams 6 vertically and horizontally, thereby forming a screen.

A magnet 10 having 2-pole, 4-pole and 6-pole adjusts the traveling path of electron beams 6 in order for the electron beams 6 to accurately strike the predetermined fluorescent materials, thereby preventing deteriorating of color purity. Since the CRT is in the high vacuum state, it tends to be easily exploded due to an external shock. Thus, the panel 1 is designed to have strength resistible against atmospheric pressure. Moreover, a reinforcing band 14 is arranged at the skirt portion of the panel 1 to disperse a stress applied to the high vacuum CRT and ensures impact resistance.

FIG. 2 is a view showing a structure of the fluorescent screen comprised in the general color CRT of FIG. 1. Fluorescent materials 15 of R (Red), G (Green), and B (Blue) colors are coated sequentially and repeatedly on spaces within the inner surface of the panel 1 between black matrices, which are spaced from each other and coated with graphite respectively, and the fluorescent materials 15 are radiated by the electron beams 6 emitted from the electron gun 11, thereby displaying colors on the screen.

A manufacturing process of the conventional CRT will be explained herein below.

The manufacturing process comprises the steps of injecting photo resist into the inner surface of the panel 1, drying and exposing the photo resist coating to make places for the three colors including R, G and B to occupy later, and developing the exposed coating, whereby the photo resist coating at the exposed portions is remained as while the photo resist at other portions than the exposed portions becomes removed. Thereafter, followed is the steps of coating a front of the inner surface of the panel 1 with graphite 14, drying, etching and developing the graphite coating, whereby graphite coated at the portions where the photo resist remains becomes removed, resulting in formation of the places for the three colors including R, G and B to occupy.

A horizontal length of the places made in this way is referred to as a BM(Black Matrix) width 13 and the above process is referred to as a BM process. In other words, the BM process is a process for manufacturing the BM width 13. After that, there is followed the steps of coating all the places on which the BM width 13 is formed with the fluorescent materials of R, G and B colors. At this stage in the process, the fluorescent materials 15 exposed to light through an exposure process become fixed and adhered on the places while fluorescent materials 15 coated up to the position on which other fluorescent materials 15 will be adhered become removed through a development process so as to form the screen. This process is referred to as a PH process in which the fluorescent materials 15 are adhered on the places where the BM width 13 is formed.

Setup of the BM width 13 is closely related to quality of the screen included in the color CRT. The BM width 13 of the general color CRT has the following distribution.

Assuming the BM width at the central portion as 100%, in the distribution of the BM width from a central portion to the direction 16 of the shorter axis, the BM width at the end portions in the direction of the shorter axis corresponds to from 85 to 99% than that at the central portion. The distribution of the BM width has a dispersion depending on the manufacturing method of the color CRT, but in general is shaped into a linear equation graph with a gradient of −1.193E-4 to 5.682E-6. Once the BM width 13 at the central portion of the fluorescent surface is 140 μm, the BM width at the end portions in the direction of the shorter axis ranges from 119 to 130 μm with brightness of 78-91% relative to the central portion. In the event that, at the end portions in the direct ion of the shorter axis, a pitch of the fluorescent screen is 660 μm and the BM width 13 is 139 μm, a BM belt becomes 81 μm, and if beam size is 220 μm, at this time, clearance in either direction becomes 30.5 μm. However, clearance of 17 μm or more is needed to satisfy a clearance of 30 degrees for rotation. In consideration of operation clearance of 20 μm in the manufacturing process, there remains clearance corresponding to just 3.5 μm, thereby causing deterioration of productivity during operation.

As the BM width 13 at the central portion becomes larger, brightness becomes improved. However, the BM width 13 could not be enlarged infinitely in order to ensure brightness uniformity with the peripheral portions.

As shown in FIG. 3, as the BM width 13 at the end portions (12 to 6 0'clock direction) in the direction of the shorter axis is increased, the brightness at the end portions becomes proportionately enhanced. In this case, however, a difference in the brightness between the end portion in the direction of the shorter axis and the central portions becomes greater, whereby a shape of brighter whiteness belt appears from the central portion toward the end portion in the direction 16 of the shorter axis, resulting in deterioration of whiteness uniformity.

In distribution of the BM width 13 from the central portion of the fluoresent screen toward a direction 17 of the longer axis and a direction18 of the diagonal axis, the BM width at doming portions, which cover from a half point to a two thirds point of a distance ranging from the central portion of the fluorescent screen to end portions of the longer axis and the diagonal axis is 95 98% relative to the central portion, when the BM width at the central portion assumes as 100%. The distribution of the BM width 13 at the end portions in the direction of the longer axis or the diagonal axis is less than 100% relative to the central portion. Once the BM width 13 at the central portion of the fluorescent screen is 140 μm, a pitch at the doming portions is 710 μm. If the BM width 13 at the doming portions is 138 μm, each BM 14 secures 99 μm. If beam size is 237 μm, at this stage, the BM 14 has clearance of 49 μm at both left and right sides on the basis of the BM width 13, respectively.

Since the BM width 13 changes a path of the electron beams 6 emitted from the electron gun due to heat expansion of the shadow mask, the frame, and the spring, there happens a mismatching with the fluorescent screen. If the BM width 13 were set to be larger in an attempt to enhance the brightness without considering the mismatching, it would bring to deterioration of the whiteness condition at an initial screen when the CRT is turned on. If a landing error is more than 19 μm when the doming amount of the color CRT is 30 μm, there happens a collision of other colors.

Further, in order to obviate a howling phenomenon radiating the other colors by electron beam's movement due to an external shock and a vibration of the shadow mask 3, at weak point of the shadow mask 3 according to the flatness of shadow mask, the BM clearance is needed to be more than 50 μm in consideration that a minimum movement amount of electron beams is approximately 20 μm when the howling was generated. Therefore, the BM width at the doming portions should be set up in consideration of the above factors.

The BM width at the end portions in the direction 17 of the longer axis and at the end portions in the direction 18 of the diagonal axis is the same as that in case of the BM width 13 at the central portion, which satisfies the level of brightness uniformity 45% maintained in the general color CRT. But comes short of 50%, which is required by buyers. Reduction of the BM width at corner portions is made just for enhancing a clearance for manufacturing process. In this instance, event though productivity would be improved but quality of the screen, namely brightness uniformity, would be deteriorated, since enlarging the BM width is contrary to the requirement of enhancing the brightness uniformity. Accordingly, the brightness uniformity is directed to being attained without drastically deteriorating operation efficiency.

Furthermore, the BM width 13 at the corner portions should be set up in consideration of the brightness uniformity and the purity clearance, etc. If the BM width 13 becomes larger infinitely in an attempt to ensure the brightness uniformity, this would give rise to proportional deterioration of the purity clearance, that is to say, a clearance for operation in the manufacturing process, thereby causing a problem in the production. On the other hand, if the BM width becomes smaller in an attempt to improve the purity clearance, this would bring to deterioration of the brightness uniformity. Therefore, both the brightness uniformity and the purity clearance are important factors to be considered when setting the BM width 13, so as to obtain satisfactory quality of the screen.

### SUMMARY OF THE INVENTION

It is, therefore, an object of the present invention to provide a color CRT(Cathode Ray Tube) having improved black matrix, which can obviate such general problems as deteriorations of whiteness uniformity, brightness uniformity, purity clearance, doming portion clearance, etc., by optimizing a BM (Black Matrix) width at peripheral portions relative to a BM width at a central portion of a fluorescent screen.

To achieve the above object, there is provided a CRT including a panel having a fluorescent screen formed at an inner surface of the panel, the fluorescent screen being provided with fluorescent materials of R(Red), G(Green), and B(Blue) colors in the form of strips and BMs arranged between the stripe-shaped fluorescent materials of R, G and B colors, wherein a change rate (a) of the BM width from a central portion of the fluorescent screen to end portions in a direction of the shorter axis satisfies the following formula:

−1.932E-4≦a≦−1.420E-4.

According to another embodiment, the present invention provides a CRT including a panel having a fluorescent screen formed at an inner surface of the panel, the fluorescent screen being provided with fluorescent materials of R, G and B colors in the form of strips and BMs arranged between the stripe-shaped fluorescent materials of R, G and B colors, wherein a BM width of the fluorescent screen from a central portion of the fluorescent screen to end portions in a direction of the shorter axis satisfies the following formula:

y=ax+b,

where y represents a BM width in a direction of the shorter axis, x represents a distance from the central portion of the fluorescent screen to end portions in a direction of the shorter axis, ‘a’ is defined by the formula

−1.932E-4≦a≦−1.420E-4,

and ‘b’ represents a BM width at the central portion of the fluorescent screen.

According to further another embodiment, the present invention provides a CRT including a panel having a fluorescent screen formed at an inner surface of the panel, the fluorescent screen being provided with fluorescent materials of R, G and B colors in the form of strips and BMs arranged between the stripe-shaped fluorescent materials of R, G and B colors, wherein a BM width of the fluorescent from a central portion of the fluorescent screen to end portions in a direction of the longer axis satisfies the following formula:

B<b<C,

where ‘b’ represents a BM width at the central portion of the fluorescent screen, ‘B’ represcents a BM width between a half point and a two thirds point from the central portion of the fluorescent screen to the end portion in the direction of the longer axis, and ‘C’ represents a BM width at the end portons in the direction of the longer axis.

According to still another embodiment, the present invention provides a CRT including a panel having a fluorescent screen formed at an inner surface of the panel, the fluorescent screen being provided with fluorescent materials of R, G and B colors in the form of strips and BMs arranged between the stripe-shaped fluorescent materials of R, G and B colors, wherein a BM width from a central portion of the fluorescent screen to end portions in the direction of the diagnal axis satisfies the following formula:

D<b<E,

where ‘b’ represents a BM width at the central portion of the fluorescent screen, ‘D’ represents a BM width between a half point and a two thirds point from the central portion of the fluorescent screen to the end portions in the direction of the diagonal axis, and ‘E’ represents a BM width at the end portions in the direction of the diagonal axis.

### BRIEF DESCRIPTION OF THE DRAWINGS

Further objects and advantages of the invention can be more fully understood from the following detailed description taken in conjunction with the accompanying drawings, in which:

FIG. 1 is a sectional view showing a general CRT(Cathode Ray Tube);

FIG. 2 is a partial sectional view showing a structure of a fluorescent screen;

FIG. 3 is a view showing a brightness distribution when a BM(Black Matrix) width at end portions in a direction of the longer side is larger;

FIG. 4 is a view showing a distribution of BM width according to the present invention;

FIG. 5 is a view showing positions of terms in respect to directions according to the present invention;

FIG. 6 is a view showing position of BM width in a direction of the longer axis;

FIG. 7 is a view showing positions of BM width in a direction of the diagonal axis; and

FIG. 8 is a view showing a brightness distribution according to the present invention.

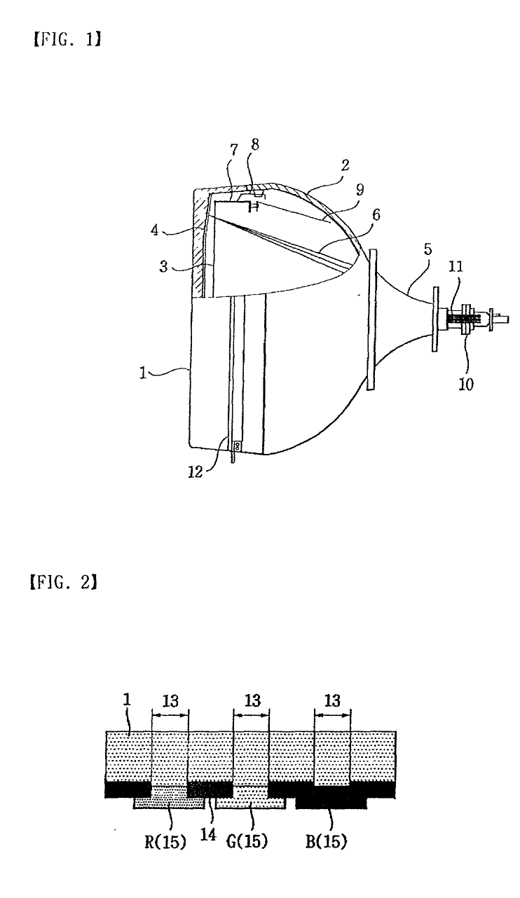

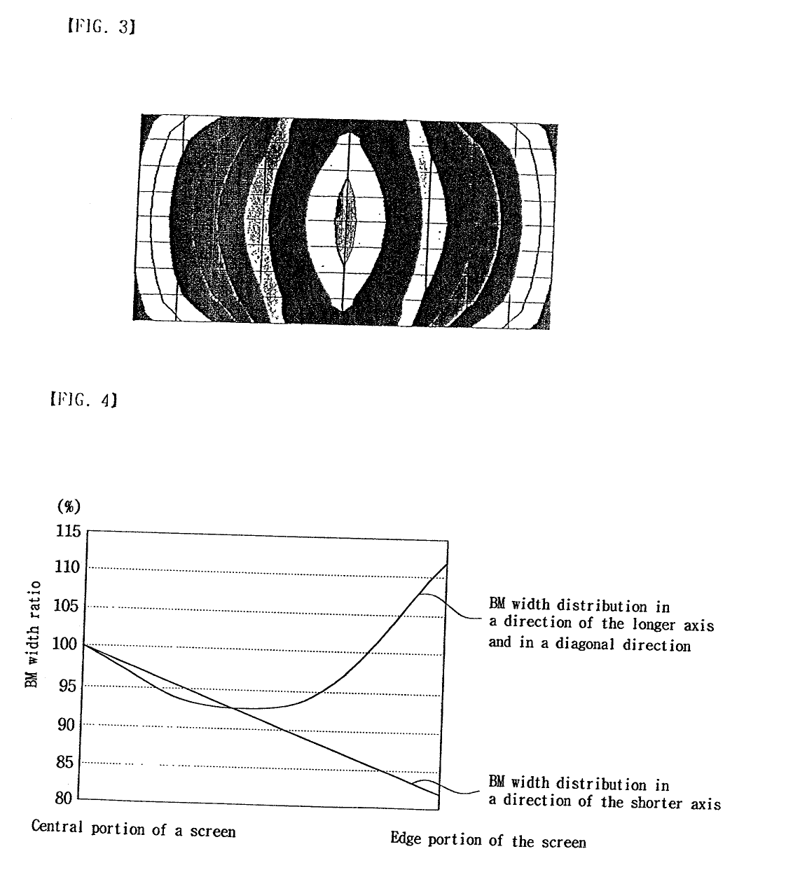

### DETAILED DESCRIPTION OF THE PREFERRED EMBODIMENT

The present invention will now be described in connection Vital preferred embodiments with reference to the accompanying drawings.

In a color CRT(Cathode Ray Tube) according to the present invention, there are performed the steps of injecting photo resists into an inner surface of a panel 1, drying the same to make places for fluorescent materials 15 of R(Red), G(Green) and B(Blue) colors to occupy later, coating a front of the inner surface of the panel 1 with graphite 14, and etching the coating to remove the graphite 14 at the places which the three color fluorescent materials occupy. The places formed in this way are referred to as a BM width 13, respectively, and the above process is referred to as a BM process.

Thereafter, there are followed the steps of coating the places where the BM width 13 is formed with the fluorescent materials 15 of R, G and B colors, and exposing the same to be fixed and adhered on the places, thereby forming a screen.

As described herein above, the places which the fluorescent materials occupy are determined depending on the BM process, and quality of the CRT is subjected to the BM width 13.

In general, formula in respect to brightness is defined as follows:

brightness=luminous efficiency compensating constant×mask transmittance rate×glass transmittance rate×beam utility rate

Here, beam utility=BM width/beam size.

As shown in the above formula, once the mask transmittance rate is determined, the brightness is increased proportionately to the BM width 13.

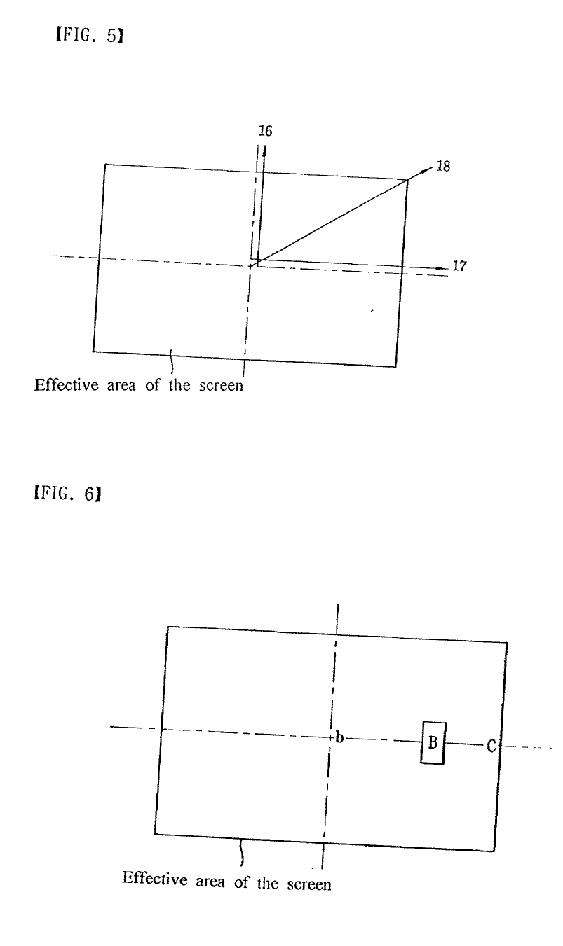

As for definition of terms in relation to directions of the color CRT according to the present invention, as best shown in FIG. 5, a direction from a center of an effective area of the screen comprised in the color CRT towards a 12 o'clock side or 6 o'clock side is referred to as a direction 16 of the shorter axis, and end portions in this direction are referred to as end portions in the direction of the shorter axis. Meanwhile, a direction from the center toward a 3 o'clock side or 9 o'clock side is referred to as a direction 17 of the longer axis, and end portions in this direction is center toward a 2 o'clock side is referred to as a direction 18 of the diagonal axis as well and end portions in this directions is referred to as end portions in the direction of the diagonal axis.

Distribution of the BM width 13 according to the present invention is illustrated in FIG. 4

A change rate of the BM width within a range from the central portion of the fluorescent screen to the end portions in the direction of the shorter axis satisfies the following formula:

−1.932E-4≦a≦−1.420E-4.

Additionally, it is desirable that the distribution of the BM width 13 within a range from the central portion of the screen toward the end portion in the direction 16 of the shorter axis shows the following linear equation graph: y=ax+b. Here, ‘y’ represents a BM width in the direction of the shorter axis, ‘x’represents a distance from the central portion of the fluorescent screen toward the end portion in the direction of the shorter axis, and ‘a’ is defined by the formula

−1.932E-4≦a≦−1.420E-4

as ‘b’ representing a BM width at the central portion of the fluorescent screen.

The BM width 13 in the direction of the shorter axis according to the present invention shows the linear equation graphical distribution, and has such a gradient that brightness of the end portions relative to the central portion is 69 to 75%, whereby it attains a circular brightness distribution over the screen as shown in FIG. 8.

Distribution of the BM width 13 at the end portions in the direction of the shorter axis is defined by the following formula:

0.76×b≦BM width at end portions in direction of shorter axis≦0.82×b.

Here, ‘b’ represents the BM width at the central portion of the fluorescent screen.

The BM width at the end portions in the direction of the shorter axis should be set to be 76 to 82% relative to the central portion in consideration of a movement amount of electron beams 6 in direction rotation, so that a clearance of 30 degrees for both left and right rotation can be satisfied and brightness ranging from 69 to 75% relative to the central portion can be achieved.

Referring to FIG. 6, distribution of the BM width within a range from the central portion of the fluorescent screen to end portion in the direction 17 of the longer axis satisfies the following formula:

B<b<C.

here, ‘b’ represents a BM width at the central portion of the fluorescent screen, ‘B’ represents a BM width between a half point and a two thirds point from the central portion of the fluorescent screen to the end portions in the direction of the longer axis, and ‘C’ represents a BM width at the end portions in the direction of the longer axis.

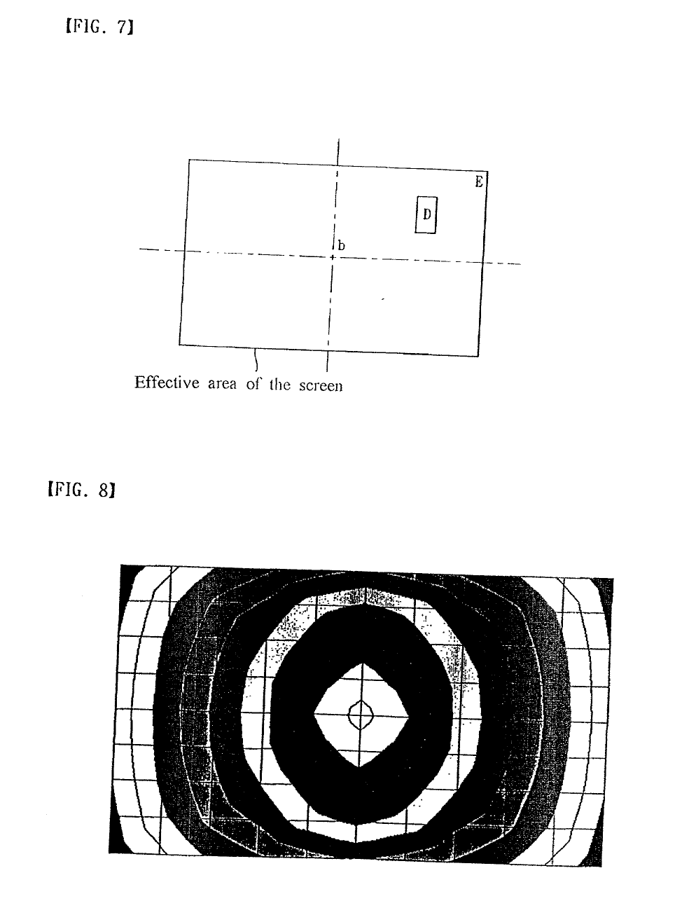

Referring to FIG. 7, distribution of the BM width from the central portion of the fluorescent screen to the end portions in the direction 18 of the diagonal axis satisfies the following formula:

D<b<E.

Here, ‘b’ represents a BM width at the central portion of the fluorescent screen, ‘D’ represents a BM width between a half point and a two thirds point from the central portion of the fluorescent screen to the end portions in the direction 18 of the diagonal axis, and ‘E’ represents a BM width at the end portions in the direction 18 of the diagonal axis.

It should be noted that, in the distribution of the BM width from the central portion toward both end portions in the direction 17 of the longer axis and in the direction 18 of the diagonal axis, the smallest is the BM width 13 between a half point and a two thirds point from the central portion of the fluorescent screen to the end portions in the direction of the longer axis or the diagonal axis. This distribution is made in consideration of the amount of doming caused by thermal deformation of components adhered on the inner surface of the panel 1, so that whiteness uniformity can be ensured, and a howling can be improved by minimizing the BM width at portions where a howling phenomenon is generated.

The distribution of the BM width 13 at the end portions in the direction of the longer axis and in the diagonal axis ensures a minimum brightness uniformity of 50% relative to the central portion of the fluorescent screen and further ensures a purity clearance, namely clearance for operation during manufacturing process, to be more than 1 mm.

Therefore, if the following formulas were satisfied, the aforementioned specific property would be satisfied:

0.90×b≦B,D≦0.93×b,

1.05×b≦C,E≦1.12×b.

Here, ‘b’ representing the BM width at the central portion of the fluorescent screen, B representing the BM width between a half point and a two thirds point from the central portion of the fluorescent screen to the end portions in the direction of the longer axis, ‘C’ representing the BM width at the end portions in the direction of the longer axis, and ‘D’ representing the BM width between a half point and a two thirds point from the central portion of the fluorescent screen to the end portions in the direction of the diagonal axis, as well as ‘E’ representing the BM width at the end portions in the direction of the diagonal axis.

An experiment was carried out to look into variations in the BM width 13 and the brightness at the peripheral portions relative to the central portion, when the BM width 13 according to a preferred embodiment of the present invention is applied to a 32″ flat-type CRT. The following Table shows the results.

TABLE

| | BM width | Change rate | | Change rate |
|---|---|---|---|---|
| Position | (μm) | of width | Brightness (FL) | of brightness |
| Central portion | 140 | 100% | 42.8 | 100% |
| End portions in | 115 | 82% | 32.2 | 75% |
| direction of | | | | |
| shorter axis | | | | |
| Doming | 130 | 93% | 34 | 79% |
| portions | | | | |
| End portions in | 155 | 111% | 24.6 | 57% |
| direction of | | | | |
| longer axis | | | | |
| Corner portions | 155 | 111% | 22.5 | 53% |

As apparent from FIG. 8, an entire brightness distribution according to the BM width 13 of the present invention is of an elongated shape in a vertical direction at the central portion over all regions and of an elongated shape in both vertical and horizontal directions as it goes toward outer portions, thereby forming an entire circular shape.

Distribution of the BM width 13 in the direction of the shorter axis shows a linear equation graph as follows:

y=(−1.420E-4)×x+0.14.

A movement amount of the electron beams 6 is approximately 50 μm when the BM width 13 at the end portions in the direction of the shorter axis is turned up to 90 degrees in a north or south direction on the basis of the east during its rotation, while a movement amount of the electron beams 6 is calculated to be 17 μm when the BM width 13 at the end portions in the direction of the shorter axis is turned up to 30 degrees left or right in the south or north direction. At this time, since a pitch of the screen is 660 μm, the BM width 13 is 115 μm and each BM 14 is 105 μm, if beam size is 220 μm, there is ensured clearance of 52 μm at both left and right sides on the basis of the BM width 13.

Thus, once clearance of 17 μm is ensured in order to ensure a clearance of 30 degrees for rotation, there is generated clearance of 35 μm. As a result, clearance of 15 m can ensure enven if dispersion (approximately 20 μm) during the manufacturing process is considered.

Since a pitch of the screen at the doming portions is 710 μm and the BM width 13 is 130 μm, each BM can ensure 107 μm. If beam size at this time is 237 μm, there is created clearance of 53 μm for the BM 14 at both left and right sides, respectively, on the basis the BM width 13. Accordingly, if a landing error is 0, and the doming amount at the doming portions is the maximum 53 μm or less, there does not happen a collision with other colors even during the movement of the election beams 6 by doming, thereby ensuring whiteness uniformity.

Furthermore, the corners can sufficiently ensure target brightness uniformity of 50% or more to be required in the stripe-type CRT. In the event that a pitch of the screen is 920 μm, each BM 14 is approximately 151 μm. If the beam size is 307 μm, each BM 14 has clearance of 75% at both left and rght sides on the basis of the BM width 13. Here, since the movement amount of the electron beams 6 is 70 μm when DY (deflection yoke) shifts 1 mm, even though there is considered a process dispersion such as the amount of mis-landing, a difference of the BM 14 between the fluorescent materials of R, G and B colors on the basis of the BM width 13 and so on, purity clearance of the minimum 1 mm or more can be ensured.

As stated above, the present invention has advantages of preventing deterioration of the whitenes unifromity caused by a difference in brightness of the screen and also preventing deterioration of brightness uniformity caused by a difference in brightness between the central portion and the peripheral portions by enabling the brightness distribution over all the regions of the fluorescent screen to be circular-shaped. The present invention has further advantages of ensuring the purity clearance and improving the productivity in the manufacturing process of the color CRT as well as obviating the howling in which since the BM width is designed to be smaller at the doming portions, the electron beams are forced to be moved due to a vibration when an external impact is imparted to the mask.

While the invention has been shown and described with reference to certain preferred embodiment thereof, it will be understood by those skilled in the art that various changes in form and details may be made therein without departing from the spirit and scope of the invention as defined by the appended claims.

what is claimed is:

1. A color CRT(Cathode Ray Tube) including a panel having a fluorescent screen formed at an inner surface of the panel, the fluorescent screen comprising fluorescent materials of R(Red), G(Green) and B(Blue) colors in the form of strips; and black matrices arranged between the strip-shaped fluorescent materials of R, G and B colors,
wherein a BM width from a central portion of the fluorescent screen to end portions in a direction of the shorter axis satisfies the following formula:
y=ax+b,
hence, ‘y’ representing a BM width in a direction of the shorter axis, ‘x’ representing a distance from the central portion of the fluorescent screen toward the end portions in a direction of the shorter axis. ‘a’ being defined by the formula
−1.932E-4≦a≦<1.420E-4,
and ‘b’ representing a BM width at the central portion of the fluorescent screen.

2. A color CRT(Cathode Ray Tube) including a panel having a fluorescent screen formed at an inner surface of the panel, the fluorescent screen comprising fluorescent materials of R, G and B colors in the form of strips; and black matrices arranged between the strip-shaped fluorescent materials of R, G and B colors,
wherein a BM width from a central portion of the fluorescent screen to end portions in a direction of the longer axis satisfies the following formula:
B<b<C,
hence, ‘b’ representing a BM width at the central portion of the fluorescent screen, ‘B’ representing a BM width between a half point and a two thirds point from the central portion of the fluorescent screen to the end portions in the direction of the longer axis, and ‘C’ representing a BM width at the end portions in the direction of the longer axis.

3. A color CRT(Cathode Ray Tube) including a panel having a fluorescent screen formed at an inner surface of the panel, the fluorescent screen comprising fluorescent materials of R, G and B colors in the form of strips; and black matrices arranged between the strip-shaped fluorescent materials of R, G and B colors,
wherein a BM width form a central portion of the fluorescent screen to end portions in a direction of the diagonal axis satisfies the following formula:
D<b<E,
hence, ‘b’ representing a BM width at the central portion of the fluorescent screen, ‘D’ representing a BM width between a half point and a two thirds point from the central portion of the fluorescent screen to the end portions in the diagonal direction, and E representing a BM width at the end portions in a direction of the diagonal axis.

4. The color CRT as claimed in claim 1, wherein the BM width at the end portions in the direction of the shorter axis satisfies the following formula.
0.75×b≦BM width at end portions in a direction of shorter axis≦0.82×b.

5. The color CRT as claimed in claim 2, wherein the BM width from the central portion of the fluorescent screen toward the direction of the longer axis satisfies the following formula:
0.90×b≦B≦0.93×b

6. The color CRT as claimed in claim 2, wherein the BM width from the central portion of the fluorescent screen toward the direction of the longer axis satisfies the following formula:
1.05×b≦C≦1.12×b

7. The color CRT as claimed in claim 3, wherein the BM width from the central portion of the fluorescent screen toward end portions in a direction of diagonal axis satisfies the following formula:
0.90×b≦D≦0.93×b

8. The color CRT as claimed in claim 3, wherein the BM width from the central portion of the fluorescent screen toward end portions in a direction of diagonal axis satisfies the following formula:
1.05×b≦E≦1.12×b

9. The color CRT(Cathode Ray Tube) as claimed in claim 1, wherein a BM width from the central portion to end portions in a direction of the longer axis satisfies the following formula:
B<b<C,
hence, ‘b’ represents a BM width at the central portion of the fluorescent screen, ‘B’ represents a BM width between a half point and a two thirds point from the central portion of the fluorescent screen to the end portions in the direction of the longer axis, and ‘C’ represents a BM width at the end portions in the direction of the longer axis.

10. The color CRT as claimed in claim 1, wherein a BM width between two discretionary points within a range form the central portion of the fluorescent screen to end portions in a diagonal direction satisfies the formula:
D<b<E,
Hence, ‘b’ represents a BM width at the central portion of the fluorescent screen, ‘D’ represents a BM width between a half point and a two thirds point from the central portion of the fluorescent screen to the end portions in a direction of diagonal axis, and ‘E’ represents a BM width at the end portions in a direction fo diagonal axis.

11. The color CRT as claimed in claim 2, wherein a BM width from the central portion of the fluorescent screen to end portions in a directional axis satisfies the formula:
D<b<E,
Hence, ‘b’ represents a BM width at the central portion of the fluorescent screen, ‘D’ represents a BM width between a half point and a two thirds point from the central portion of the fluorescent screen to the end portions in a direction of diagonal axis, and ‘E’ represents a BM width at the end portions in a direction of diagonal axis.

12. The color CRT as claimed in claim 9, wherein a BM width from the central portion of the fluorescent screen to end portions in a directional axis satisfies the formula:
D<b<E,
Hence, ‘b’ represents a BM width at the central portion of the fluorescent screen, ‘D’ represents a BM width between a half point and a two thirds point from the central portion of the fluorescent screen to the end portions in a direction of diagonal axis, and ‘E’ represents a BM width at the end portions in a direction of diagonal axis.

13. A color CRT(Cathode Ray Tube) including a panel having a fluorescent screen formed at an inner surface of the panel, the fluorescent screen comprising fluorescent materials of R, G and B colors in the form of strips; and black matrices arranged between the strip-shaped fluorescent materials of R, G and B colors,
wherein a change rate (a) of a black width from a central portion of the fluorescent screen to end portions in a direction fo the shorter axis satisfies the following formula:
−1.932E-4≦a≦−1.420E-4.
